(19) United States
(12) Patent Application Publication
(10) Pub. No.: US 2026/0091806 A1
(43) Pub. Date: Apr. 2, 2026

(54) AUTONOMOUS VEHICLE TRAJECTORY LOSS MONITOR

(71) Applicant: Zoox, Inc., Foster City, CA (US)

(72) Inventors: Kshitij Agarwal, San Mateo, CA (US); Varun Agrawal, Mountain View, CA (US); Sven Brüggemann, San Francisco, CA (US); Brian Michael Filarsky, San Francisco, CA (US); Glenn Xavier Liem, San Francisco, CA (US); Aviral Singh, Foster City, CA (US); Joshua Axel Seymour Stubbs, San Francisco, CA (US); Lingqian Yuan, Mountain View, CA (US); Andrew Zhang, San Mateo, CA (US)

(21) Appl. No.: 18/902,524

(22) Filed: Sep. 30, 2024

(51) Int. Cl. B60W 60/00; B60W 30/14; B60W 30/18

(52) U.S. Cl. CPC B60W 60/0015; B60W 30/146; B60W 30/18009; B60W 60/0011

(57) ABSTRACT

Techniques are described herein for generating and performing backup trajectories on an autonomous vehicle, based on failing to receive a driving trajectory from a primary trajectory generation system. A trajectory execution system may be configured to periodically receive driving trajectories from the trajectory generation system and implement the trajectories via the drive system of the autonomous vehicle. The trajectory generation system described herein also may generate and validate future safety trajectories in order to determine whether the trajectory execution system can generate valid safety trajectories in response to trajectory loss event. The future safety trajectories generated by the trajectory generation system may be based on a resettable trajectory loss timer of the trajectory execution system and may apply a similar safety algorithm to the future vehicle state and location based on the primary driving trajectory determined by the trajectory generation system.

### BACKGROUND

An autonomous vehicle may include various software-based systems, hardware-based systems, and/or controllers to guide the vehicle through an environment. For example, a controller of an autonomous vehicle can use sensor systems, object perception and prediction systems, and route planning and optimization techniques to determine driving paths and to guide the vehicle through environments containing static and dynamic objects. In some cases, autonomous vehicle control systems may include multiple different computer systems and/or separate computing devices configured to communicate via on-vehicle network components. For example, one or more computer systems/devices on an autonomous vehicle may include components configured to analyze the current driving environment and determine driving trajectories for the vehicle, while additional computer systems/devices may include components configured to invoke the drive system on the autonomous vehicle to perform the determined trajectories. Within such autonomous vehicles, component and system failures can include individual failures of one or more of the computer systems and/or devices, as well as communication failures between various systems/devices.

### BRIEF DESCRIPTION OF THE DRAWINGS

The detailed description is described with reference to the accompanying figures. In the figures, the leftmost digit(s) of a reference number identifies the figure in which the reference number first appears. The use of the same reference numbers in different figures indicates similar or identical components or features.

FIG. 1 illustrates a block diagram of an example vehicle including a trajectory generation system and trajectory execution system configured to implement a trajectory loss timer, in accordance with one or more examples of the disclosure.

FIG. 2 illustrates an example vehicle architecture including a trajectory generation device configured to generate trajectories, and a trajectory execution device configured to store and implement trajectories on the vehicle, in accordance with one or more examples of the disclosure.

FIG. 3 is an example diagram depicting a vehicle traversing a driving trajectory, including a trajectory execution system configured to implement a trajectory loss timer, in accordance with one or more examples of the disclosure.

FIG. 4 is an example diagram depicting a vehicle traversing a driving trajectory, including a trajectory generating system configured to generate and evaluate predictive safety trajectories, in accordance with one or more examples of the disclosure.

FIG. 5 illustrates a block diagram of an example system for implementing the techniques described herein, according to an example of the present disclosure.

### DETAILED DESCRIPTION

This application describes techniques for generating, evaluating, and performing trajectories on an autonomous vehicle. In some examples, an autonomous vehicle may include a trajectory generation system configured to periodically determine optimal driving trajectories for the vehicle, and a separate trajectory execution system configured to execute the driving trajectories using the actuators of the vehicle drive systems (e.g., drive, braking, and steering systems, etc.). Within various autonomous vehicles, the trajectory generation system and trajectory execution system may execute on the same computing device within the vehicle or may execute on different computing devices that communicate via on-board communication network components.

During normal operation of an autonomous vehicle, the trajectory generation system may be configured to generate and transmit driving trajectories to the trajectory execution system at a predetermined frequency (e.g., every 100 ms, every 200 ms, etc.). The trajectory execution system may be configured to receive the driving trajectories in accordance with the predetermined schedule and to execute the trajectories to control the movement of the autonomous vehicle. However, various issues may arise that may prevent the trajectory execution system from receiving valid driving trajectories from the trajectory generation system according to the predetermined schedule. For example, errors or failures within one or more of the systems, and/or network communication issues between the systems, may cause the trajectory execution system not to receive updated driving trajectories from the trajectory generation system at the expected times. Additionally, various system errors and/or network issues may cause the driving trajectories provided by the trajectory generation system to be delayed or corrupted, so that even when a trajectory is received it may be unsafe or kinematically infeasible for the vehicle to perform. As used herein, situations in which valid driving trajectories are not provided to, or received by, the trajectory execution system for a period of time on the vehicle may be referred to as “trajectory loss” situations.

When persistent trajectory loss (e.g., for longer than a threshold time period) occurs, it may be desirable for the vehicle to execute a safety trajectory, such as pulling over the vehicle or performing another safe stopping trajectory. Although this application describes examples of determining and executing safety trajectories in response to persistent trajectory loss, safety trajectories may also be performed in response to various other on-vehicle malfunctions and/or error conditions. Safety trajectories may refer to default or backup trajectories designed to put the vehicle into a safe condition in the event of persistent trajectory loss. In some examples, safety trajectories may be trajectories designed to bring the vehicle to a quick and safe stop, while minimizing the likelihood of a collision or other unsafe driving conditions. However, as described herein, different safety trajectories may apply different safety algorithms that implement various stopping and non-stopping safety trajectories, including different deceleration rates, different steering rates/lateral movements, different target destinations for stopping trajectories, and the like. In some cases, an autonomous vehicle may be configured to execute the same safety trajectory (e.g., applying a straight-line stopping algorithm with a fixed deceleration) for all errors or malfunctions on the vehicle that are significant enough to trigger transitioning from the driving trajectory to a safety trajectory. In other examples, the autonomous vehicle may be configured to generate and/or determine a particular safety trajectory from any number of potential safety trajectories (e.g., trajectories using different safety algorithms), based on the type and severity of the vehicle error(s), the current vehicle state (e.g., velocity, lane position, etc.), the current driving conditions and/or driving environment, etc. In some instances, safety trajectories may be determined without using any sensor/perception data captured on the vehicle, or using a subset of sensor data (e.g., due to degradation of certain sensor/perception data), because such data may be unavailable or unreliable due to the vehicle malfunctions or errors.

Certain existing systems may address trajectory loss by using a trajectory generation system that periodically generates separate safety trajectories (e.g., safe stopping trajectories) which can be transmitted to the trajectory execution system at a predetermined frequency along with the corresponding primary driving trajectories. In these systems, the trajectory execution system may store the safety trajectories, and, in the event of a subsequent trajectory loss the trajectory execution system may perform the most recent safety trajectory received from the trajectory generation system.

However, such systems may have various drawbacks that may result in potential inefficiencies and safety risks for the vehicle. For example, when a trajectory execution system first fails to receive a driving trajectory according to its predetermined schedule/frequency (or receives a corrupted driving trajectory that cannot be executed), the trajectory execution system may not know the nature of the error or how long it will be until a new valid driving trajectory is received from the trajectory generation system. Therefore, it may be difficult for the trajectory execution system to determine when to trigger the execution of a safety trajectory (e.g., a safe stopping maneuver). If the trajectory execution system triggers a safety trajectory too soon, such as in response to a single lost trajectory or a minor delay caused by network latency, then the vehicle may be overly sensitive to minor errors and may pull over or perform in-lane stopping too frequently and unnecessarily. In contrast, if the trajectory execution system waits too long to trigger a safety trajectory, then the collision/accident risk for the vehicle may increase.

Additionally, the longer the trajectory execution system waits before triggering a previous safety trajectory, the more outdated (or stale) the safety trajectory executed by the vehicle may be. As an example, a trajectory execution system may receive a driving trajectory and safety trajectory from a trajectory generation system at a first time (t=0 milliseconds (ms)), just before an on-vehicle error or malfunction occurs. Based on the on-vehicle error (e.g., trajectory generation system failure, a loss of network connection, etc.), the trajectory execution system might not receive subsequent driving trajectories or safety trajectories according to the predetermined schedule (e.g., every 200 ms). In this case, if the trajectory execution system waits 250 ms before triggering the most recently received safety trajectory, then the safety trajectory may be relatively recent (e.g., outdated by 250 ms) when it is executed. However, if the trajectory execution system waits 1 second before triggering the safety trajectory, then the safety trajectory may be more stale (e.g., outdated by 1 second) when it is executed. As described below, attempting to execute a stale safety trajectory on the vehicle can have various negative effects on vehicle safety, passenger comfort and experience, and driving efficiency.

A vehicle trajectory may be stored as a sequence of trajectory points representing different vehicle states at different sequential times. Each point in a trajectory may include corresponding vehicle state data, such as a vehicle location, pose, movement vector, and various other vehicle state data, as well as vehicle command controls associated with the trajectory point. Each trajectory generated for a vehicle (both primary driving trajectories and safety trajectories) may assume a particular starting state for the vehicle (e.g., a current location, pose, velocity, steering angle, etc.), and the trajectory may be designed to transition the vehicle from that staring state to a desired end state. Thus, when a trajectory execution system attempts to execute a stale trajectory in which the trajectory starting state does not match the current vehicle state, the vehicle may perform various undesirable driving maneuvers (e.g., swerving, jerking, excess acceleration or braking, etc.) as it attempts to move the vehicle from its current state to the correct state on the stale trajectory.

To address the issues and technical challenges of trajectory loss in autonomous vehicles, the techniques described herein include a trajectory execution system configured to periodically generate safety trajectories separate from the trajectories provided by the trajectory generation system. In some examples, the trajectory execution system may implement a trajectory loss timer with a time threshold (e.g., 500 ms, 1000 ms, etc.) that triggers the execution of a safety trajectory. The trajectory loss timer may be reset each time a valid driving trajectory is received from the trajectory generation system. When the time threshold of the trajectory loss timer is reached or exceeded, the trajectory execution system may transition from executing the most recent driving trajectory received from the trajectory generation system to executing the safety trajectory generated more recently by the trajectory execution system.

In some examples, the time threshold used by the trajectory loss timer may be predetermined and/or fixed time threshold for determining when the trajectory execution system will transition the vehicle from the most recent driving trajectory provided by the trajectory generation system to the more recent safety trajectory. The time threshold can be determined as an optimal time that balances the risk of unnecessary transitions to safety trajectories (which may negatively impact the driving trip and may increase the potential risk of rear-impact collisions) with the increased risk of continuing to follow the (minimally) outdated or stale driving trajectory from the trajectory generation system. As noted above, in some cases, the time threshold used by the trajectory execution system may be a fixed threshold used for all driving scenarios. In other cases, the trajectory execution system may select from different time thresholds and/or modify or weight the time threshold based on the current vehicle state (e.g., velocity, steering angle, lane position, etc.) and the current driving conditions or environment (e.g., current traffic level, positions of other nearby objects relative to the vehicle, etc.).

The trajectory execution system may include a safety system configured to generate safety trajectories for the vehicle, which may be used as an alternative to or in addition to one or more safety systems within the trajectory generation system. Thus, in some instances, the autonomous vehicle may include multiple separate safety systems in the trajectory generation system and in the trajectory execution system. These safety systems each may generate safety trajectories independently, using the same safety algorithms or different algorithms. Therefore, when trajectory loss occurs due to a system failure or lost network connection, the trajectory execution system can continue to generate additional safety trajectories, after trajectories from the trajectory generation system are no longer being received.

In some cases, when the trajectory execution system and trajectory generation system both include safety systems, the trajectory execution system may store safety trajectories received from the trajectory generation system as well as additional safety trajectories generated by its internal safety system. In such cases, when the trajectory execution system has determined to transition from the driving trajectory to a safety trajectory, it may choose between the most recent safety trajectory from the trajectory generation system and the most recent safety trajectory from its internal safety system. In some examples, the trajectory execution system may be configured to use the safety trajectory generated by its internal safety system when trajectory loss occurs and to use a safety trajectory received by the trajectory generation system for all other vehicle errors and failures that necessitate transitioning to a safety trajectory.

In some examples, the safety system of the trajectory execution system may receive the safety algorithm used by the trajectory generation system (e.g., defining deceleration rates, lateral movement, etc.) and may use the same safety algorithm when generating its own safety trajectories. Additionally or alternatively, the safety algorithm used by the trajectory execution system may be based on the length of the time threshold of the trajectory loss timer. For instance, when longer time thresholds are used, the safety algorithm may include higher deceleration rates that slow or stop the vehicle more quickly. In contrast, when a shorter time threshold is used, the safety algorithm may include lower deceleration rates that more gradually slow or stop the vehicle.

As noted above, the safety trajectories generated by the trajectory execution system may be associated with the specific time that the vehicle is transitioned between the driving trajectory and the safety trajectory. Thus, these safety trajectories may provide technical advantages over the safety trajectories generated by the trajectory execution system, which are generated at and/or associated with previous times (e.g., before the occurrence of the trajectory loss). In some cases, when generating a safety trajectory, the trajectory execution system may determine an updated vehicle location (using current localization data) and/or an updated vehicle pose (using current vehicle pose data to determine a position and/or orientation), and then may generate the safety trajectory based on the updated location and/or pose data. Additionally or alternatively, the trajectory execution system may generate safety trajectories prior to reaching the time threshold of the trajectory loss time, and thus, also determination whether or not a trajectory transition will occur. In these cases, the trajectory execution system may determine the future time when the trajectory loss timer is scheduled to expire and may anticipate that a transition may potentially occur at that future time. The trajectory execution system also may determine the predicted location and predicted pose of the vehicle at the future time (the potential transition time) and may generate a safety trajectory for the vehicle associated with the future time.

As shown in these examples, by determining and/or predicting the updated vehicle location and pose data at the transition time, the techniques herein may improve the quality of safety trajectories generated by the trajectory execution system. Because these safety trajectories may be associated with and may start from vehicle states that are closer to the actual state of the vehicle at the transition time, these trajectories may be kinematically feasible, easier for the vehicle to follow (or track), and may result in the vehicle performing more precise safe stopping maneuvers. The safety trajectories generated by the trajectory execution system also may provide improvements over the safety trajectories generated by the trajectory generation system, which were generated prior to trajectory loss and may be based on previous (potentially outdated and/or stale) vehicle states.

Although examples herein may describe safety trajectories as stopping or safe stopping trajectories, in other examples the same techniques may be used to generate and perform non-stopping safety trajectories by the trajectory execution system. For instance, a safety trajectory may perform a driving maneuver in which the vehicle decelerates from its current speed and then proceeds at a slow and steady rate. Such safety trajectories may be used as intermediate safety trajectories that may be applied after reaching a first trajectory loss time threshold, but before reaching a longer threshold after which a safe stopping trajectory is applied. In other examples, deceleration but non-stopping safety trajectories may be used when the vehicle has perceived a risk of a rear-impact collision (e.g., a tailgating and/or inattentive trailing vehicle).

Further, as noted above, the safety trajectories generated by the trajectory execution system may or not have lateral movement components. Certain safety trajectories may apply a straight-line deceleration or stopping algorithm, while other safety trajectories may follow the current steering angle of the vehicle, or may navigate the vehicle to the road shoulder, etc.

Additional techniques described herein to address trajectory loss in autonomous vehicles may be performed by the trajectory generation system, either solely or in combination with the trajectory execution system. For instance, the trajectory generation system may use the time threshold of the trajectory loss timer to predetermine future safety trajectories for the vehicle to use in the event that trajectory loss subsequently occurs. In some cases, the trajectory generation system may generate the future safety trajectories concurrently with generating driving trajectories and/or safety trajectories (e.g., using the same predetermined schedules). At a particular scheduled time, along with generating a current driving trajectory and one or more current safety trajectories, the trajectory generation system also may generate a future safety trajectory that is designed to be performed by the vehicle at the future time, if the trajectory execution system transitions the vehicle to a safety trajectory (e.g., if the trajectory loss time threshold has been reached). To generate the future safety trajectory, the trajectory generation system may use the current driving trajectory to predict the location and pose of the vehicle at the future time (and/or additional future state data for the vehicle) when a transition based on trajectory loss could potentially occur. Such a future safety trajectory may also be determined based on a different algorithm than is used for generating a primary trajectory in the primary compute system but the same as used in the trajectory execution system

In some cases, after generating a future safety trajectory, the trajectory generation system may transmit the future safety trajectory to the trajectory execution system. When the trajectory execution system receives the future safety trajectory prior to a trajectory loss occurring, it may store the future safety trajectory to be performed subsequently after the trajectory loss has occurred and the time threshold has been reached. In these cases, the trajectory generation system may periodically generate and transmit future safety trajectories associated with future potential transition times, for example, according to the same predetermined frequency that primary driving trajectories are transmitted. The trajectory execution system may receive and store the future safety trajectories, and (if necessary) may perform the future safety trajectory associated with a transition time when the trajectory loss time threshold has been reached, or otherwise discarding the future safety trajectory.

Additionally or alternatively, the trajectory generation system may generate and then evaluate the future safety trajectories, to determine if the future trajectories are predicted to be safe and/or kinematically feasible for the vehicle to perform. For instance, if the trajectory generation system determines that performing a future safe stopping trajectory at its potential future execution time (e.g., when the trajectory loss time threshold has been reached) will cause the vehicle to drive past the stopping point of the current primary driving trajectory, then future safe stopping trajectory may be unsafe or not feasible for the vehicle. Based on the evaluation, the trajectory generation system may determine that the trajectory execution system may be unable to generate a valid (e.g., kinematically feasible and safe) safety trajectory at a particular future time (e.g., a potential transition time necessitated by trajectory loss). In these cases, the trajectory generation system may perform one or more responsive actions, such as initiating an immediate vehicle pullover command, initiating a delayed vehicle pullover command (e.g., within 10 mins, 30 mins, 60 mins, etc.), transmitting a notification to a remote operator system, and/or revising the primary driving trajectory. In other cases, based on the evaluation the trajectory generation system may determine that the trajectory execution system should be able to generate a valid safety trajectory at the future time. In these cases, the trajectory generation system may transmit the passing future safety trajectory to the trajectory execution system or may discard the future safety trajectory and rely on the trajectory execution system to generate a valid safety trajectory (if necessary at the future time).

The techniques described herein provide a number of technical advantages and improvements in autonomous vehicle systems in which trajectory loss may occur. In some examples described herein, a trajectory execution system may initiate and maintain a trajectory loss timer, including resetting the timer when valid driving trajectories are received from the trajectory generation system. Additionally, the safety trajectories generated by the trajectory execution system may take into account the updated vehicle state (e.g., location, pose, etc.) at the time that the safety trajectory will be performed, rather than relying on a previous safety trajectory received prior to the trajectory loss. Thus, the trajectory execution system described herein may generate and perform safety trajectories that are more current and accurate when a trajectory loss occurs, thereby providing smoother transitions to safety trajectories and reducing the likelihood of the vehicle performing abrupt or potentially unsafe maneuvers.

Additionally, as described herein, the time threshold of the trajectory loss timer can be configured (and/or modified while driving) to optimize the behavior of the vehicle. For instance, an optimal time threshold for transitioning to a safety trajectory may take into account the risks of transitioning too soon (e.g., unnecessary transitions, potential rear-impact collisions) and the risks of transitioning too late (e.g., potential side or front-impact collisions), to determine an optimally safe and efficient trajectory loss time threshold. Further, in some examples, the trajectory execution system may include a safety system that can implement similar or identical safety algorithms to those used by the trajectory generation system, thereby ensuring consistency in safety calculations even when the trajectory generation system is unavailable. This redundancy of safety systems may enhance the overall safety and reliability of the autonomous vehicle.

The techniques described herein also provide technical advantages by enabling the trajectory execution system to generate multiple safety trajectories at different time points (e.g., different potential transition times), allowing for a more flexible and robust response to trajectory loss situations. The techniques herein also may provide technical benefits by implementing a prediction mechanism within the trajectory generation system, which may evaluate the feasibility of potential future safety trajectories based on the current driving trajectory and the time threshold of the trajectory loss timer. By predicting and assessing these safety trajectories in advance, the trajectory generation system can proactively identify scenarios where a safe stopping maneuver might not be possible, allowing for earlier intervention and/or alternative safety measures to be implemented.

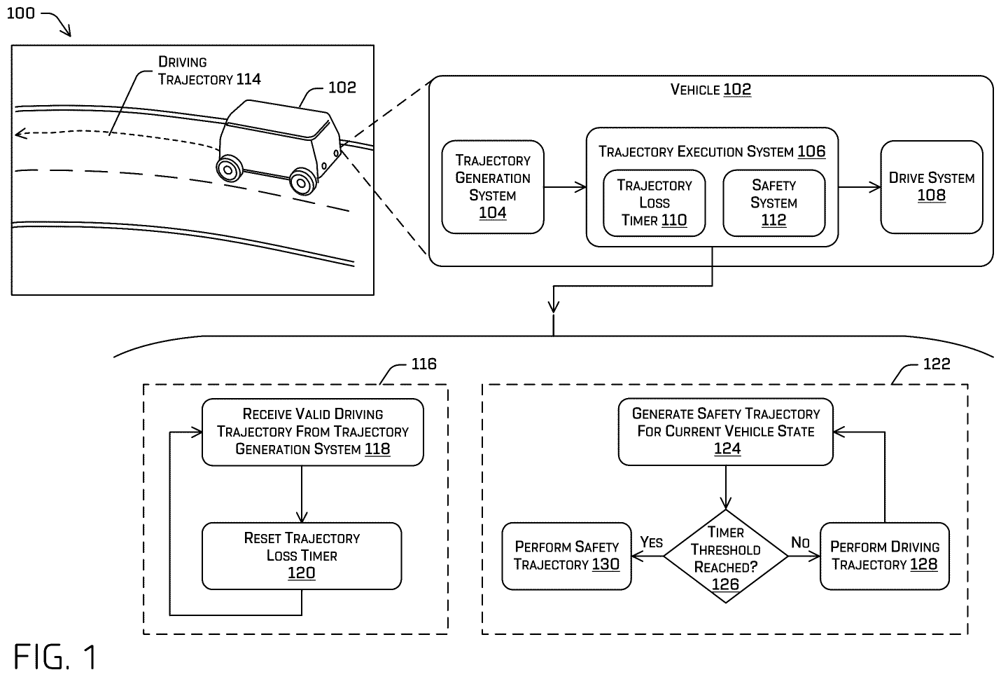

FIG. 1 illustrates a block diagram of an example vehicle 102 configured to monitor for and address trajectory loss situations on the vehicle 102. As shown in this example, the vehicle 102 may include a trajectory generation system 104 configured to generate primary driving trajectories for the vehicle, a trajectory execution system 106 configured to execute the trajectories, and a drive system 108 including actuators to control the drive, braking, and steering systems of the vehicle 102. In FIG. 1, an example environment 100 is shown that includes the vehicle 102 traversing the environment 100. In this example, the vehicle 102 may be traveling on a road. In some instances, the vehicle 102 may represent a driverless vehicle, such as an autonomous vehicle. However, this is merely an example, and the systems and methods described herein may be incorporated into any ground-borne, airborne, or waterborne vehicle, including those ranging from vehicles that need to be manually controlled by a driver at all times, to those that are partially or fully autonomously controlled. The vehicle 102 is shown following a driving trajectory 114, which may be determined by a trajectory generation system 104 based on sensor data received from one or more sensor system(s) on the vehicle 102. The driving trajectory 114, which may be generated by the trajectory generation system 104 to navigate the vehicle 102 to an intended destination within the environment 100 may be referred to herein as a primary driving trajectory. Examples of vehicle trajectories are discussed in, for example, U.S. patent application Ser. No. 16/151,607 and U.S. patent application Ser. No. 15/843,512, which are incorporated by reference herein in their entireties and for all purposes.

In some examples, the trajectory generation system 104, the trajectory execution system 106, and the drive system 108 may be implemented within a single computing device on the vehicle 102. However, in other examples, two or more of the trajectory generation system 104, the trajectory execution system 106, and the drive system 108 may be implemented on different computing devices (e.g., different CPUs, different circuit boards, etc.) on the vehicle 102, and may be configured to communicate via one or more computer network components (e.g., network switches).

The trajectory generation system 104, described in more detail below, may be configured to generate the primary driving trajectories for the vehicle 102 to use to traverse the environment 100 from its current state to an intended destination (or end state). In various examples, the trajectory generation system 104 may receive and analyze sensor data captured by sensors on the vehicle 102. The trajectory generation system 104 may use the sensor data, map data of the environment 100, the current vehicle state, and the intended destination of the vehicle 102 to determine one or more optimal driving trajectories (e.g., primary driving trajectories) designed to move the vehicle 102 towards its intended end state in a safe and efficient manner. In some examples, the trajectory generation system 104 may include one or more trained machine-learned models, including a perception component, prediction component, and planning component to analyze the environment 100, predict the movements/trajectories of other agents in the environment, and determine one or more driving trajectories for the vehicle 102.

The trajectory execution system 106 may be configured to receive primary driving trajectories from the trajectory generation system 104, and to perform the driving trajectories by transmitting instructions to the drive system 108. During normal operation of the vehicle, the trajectory execution system 106 may receive driving trajectories in accordance with a predetermined trajectory transmission schedule of the trajectory generation system 104 (e.g., every 100 ms, every 200 ms, etc.). After receiving a driving trajectory, the trajectory execution system 106 may use a vehicle control component (or vehicle control system) to determine a set of control commands (e.g., actuator commands) that will cause the vehicle 102 to perform the trajectory.

As shown in this example, the trajectory execution system 106 may include components to detect and respond to safety issues including, for example, trajectory loss situations using the techniques described herein. For example, the trajectory execution system 106 may include a trajectory loss timer 110 and a safety system 112. The trajectory loss timer 110 may be used to monitor the amount of time since a new driving trajectory has been received from the trajectory generation system 104. Thus, after initiating the trajectory loss timer 110, trajectory execution system 106 may reset the timer in response to receiving an updated (and valid) driving trajectory. Until the time threshold of the trajectory loss timer 110 is reached, the trajectory execution system 106 may control the perform the most recent driving trajectory received from the trajectory generation system 104. However, reaching the time threshold of the trajectory loss timer 110 may indicate a trajectory loss situation that may cause the trajectory execution system 106 to transition the vehicle 102 from performing the latest driving trajectory to performing a separate safety trajectory.

The trajectory execution system 106 also may include a safety system 112 configured to generate safety trajectories to be performed when trajectory loss situations occur. As discussed herein, the trajectory generation system 104 may include a separate safety system in some examples, and the safety system 112 may use similar or the same safety algorithms (e.g., deceleration rates, lateral movement, stopping end states, etc.) to determine a safe and efficient stopping trajectory for the vehicle 102. As noted above, the safety system 112 may provide particular advantages in trajectory loss situations, because the trajectory execution system 106 may be unable to receive driving trajectories and safety trajectories (or may receive corrupted trajectories) during the trajectory loss period. Accordingly, when the trajectory loss timer 110 determines that a trajectory loss time threshold has been reached, the safety system 112 may be used to generate an appropriate safety trajectory for the vehicle 102.

Unlike the previous driving trajectories and/or safety trajectories received from the trajectory generation system 104 before the trajectory loss occurred, the safety system 112 may take into account the current state of the vehicle 102 at the transition time to the safety trajectory. For example, the safety system 112 may receive and use vehicle localization data, vehicle pose data, map data, and the like, to generate a safety trajectory associated with the particular transition time. In some cases, the safety system 112 may generate safety trajectories according to a predetermined schedule/frequency, and may discard safety trajectories that become unnecessary when trajectory loss does not occur. Additionally, in some instances, the safety system 112 may generate safety trajectories to be associated with particular transition times, and may generate those safety trajectories before the associated transition times (e.g., using predicted vehicle state data, a predicted vehicle location, a predicted vehicle pose, etc.).

The drive system 108, which may be implemented within the trajectory execution system or as a separate system, may be configured control a plurality of actuators of the vehicle 102 for guiding the vehicle 102 along determined trajectories. The actuators of the drive system 108 may include, for example, braking actuators (e.g., brake calipers), steering actuators (e.g., hydraulic cylinders), and/or drive actuators (e.g., electric motors). More generally, the drive system 108 may perform functions associated with controlling steering, braking, inverters, traction system(s), parking brake(s), vehicle suspension, and the like, in association with executing a trajectory for the vehicle 102. As part of this, the drive system 108 may issue commands to the actuators for performing certain actions based on a determined (driving or safety) trajectory, such as braking at certain deceleration rate or deacceleration profile, etc.

Turning to the flow diagrams in FIG. 1, this example depicts two processes that may be executed by the trajectory execution system 106. In the first process 116, the trajectory execution system 106 may maintain the trajectory loss timer 110 used to monitor for and detect a trajectory loss event. At operation 118, the trajectory execution system 106 may receive a valid driving trajectory from the trajectory generation system 104. In some examples, after receiving a primary driving trajectory the trajectory execution system 106 may execute a validation process to confirm that the received trajectory is valid (e.g., safe and kinematically feasible for the vehicle 102 to execute). At operation 120, in response to receiving and validating the driving trajectory, the trajectory execution system 106 may reset the trajectory loss timer 110.

In the second process 122, the trajectory execution system 106 may periodically generate updated safety trajectories and determine which trajectory the vehicle 102 should follow. In some examples, process 122 may be performed periodically according to a predetermined frequency (e.g., every 100 ms, every 200 ms, etc.). At operation 124, the trajectory execution system 106 may use the safety system 112 to generate an updated safety trajectory, taking into account the current vehicle state data (e.g., current vehicle location, pose, etc.) of the vehicle 102. At operation 126, the trajectory execution system 106 may evaluate the trajectory loss timer 110 to determine whether the time threshold has been reached. If the time threshold of the trajectory loss timer 110 has not yet been reached (126:No), then in operation 128 the trajectory execution system 106 may continue performing the most recent driving trajectory received from the trajectory generation system 104. However, if the time threshold of the trajectory loss timer 110 has been reached (126:Yes), then in operation 130 the trajectory execution system 106 may transition the vehicle 102 to perform the safety trajectory generated in operation 124.

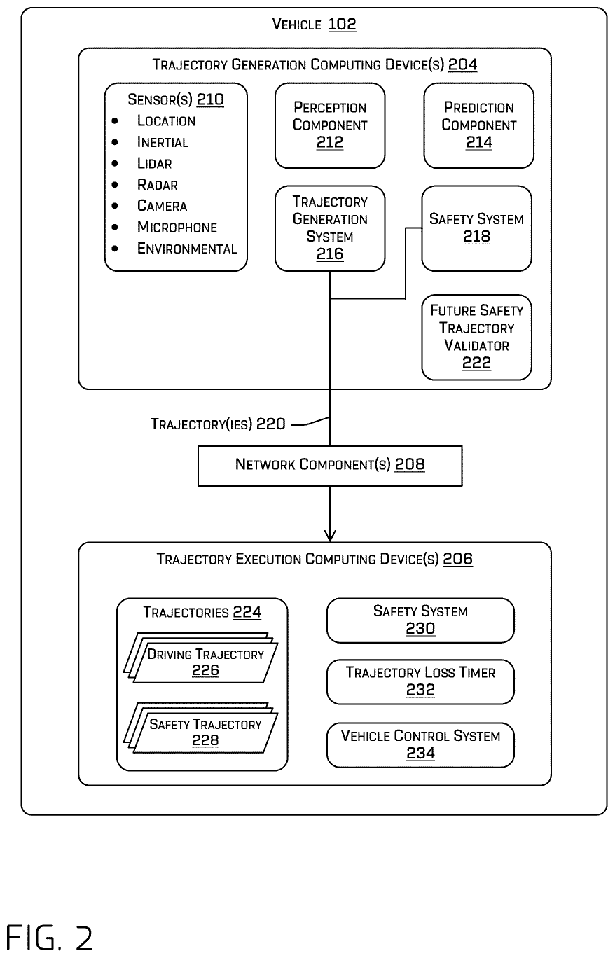

FIG. 2 depicts an example of a multi-device architecture that may be implemented within a vehicle 102. As discussed above in FIG. 1, the trajectory generation system and trajectory execution system may be implemented on the same computing device or different computing devices within the vehicle 102. In this example, the trajectory generation system 216 (which may be similar or identical to the trajectory generation system 104) may execute on a trajectory generation computing device 204, while the components of the trajectory execution system 106 may execute on a separate trajectory execution computing device 206. The trajectory generation computing device 204 and trajectory execution computing device 206 may include separate boards, processors, CPU memory, clocks, etc., and may be configured to communicate via network components 208 (e.g., network switches) on the vehicle 102.

In some examples, the trajectory generation computing device 204 may comprise a primary artificial intelligence (AI) based computing device on the vehicle 102. For example, the trajectory generation computing device 204 may include various machine learning models trained to detect and analyze aspects of the driving environment, predict the future behaviors of objects/agents, and determine optimal driving trajectories for the vehicle 102.

As shown in this example, as the vehicle 102 travels throughout a driving environment, it may capture data via sensor systems 210. The sensor systems 210 may include, for example, time of flight sensors, LIDAR sensors, RADAR sensors, SONAR sensors, image sensors, audio sensors, infrared sensors, location sensors, environmental sensors, etc., or any combination thereof. The sensor systems 210 may be disposed to capture data associated with the current driving environment. The sensor data may be processed using one or more components (e.g., machine-learned (ML) components) to analyze the environment and perform vehicle driving functionality. For instance, the perception component 212 may include ML models configured to detect object(s) in the environment surrounding the vehicle 102, classify the objects, and segment the sensor data and/or other representations of the environment, and determine characteristics associated with the various objects. The prediction component 214 may include functionality (e.g., ML models) configured to generate predicted information associated with the objects in the environment (e.g., predicted locations, trajectories, etc.).

The trajectory generation system 216 may be similar or identical to the trajectory generation system 104 in FIG. 1. As described above, the trajectory generation system 216 may be configured to generate driving trajectories that the vehicle 102 may use to traverse the driving environment from its current state to a desired end state. In various examples, the trajectory generation system 216 may use sensor data captured by sensor systems 210, perception data from the perception component 212, and prediction data from the prediction component 214. Additionally, the trajectory generation computing device 204 in this example includes a safety system 218 configured to generate safety trajectories (e.g., backup trajectories) for the vehicle 102. As described above, the vehicle 102 may be transitioned from a driving trajectory to a safety trajectory (e.g., a deceleration trajectory, safe stopping trajectory, etc.) in response to an error or malfunction on the vehicle 102.

During normal vehicle operations, the trajectory generation computing device 204 may be configured to generate and transmit one or more trajectories 220 to the trajectory execution computing device 206 in accordance with a predetermined schedule and/or frequency (e.g., every 100 ms, 200 ms, 500 ms, etc.). During normal operation of the vehicle 102, the driving condition trajectories 220 provided by the trajectory generation computing device 204 may include primary (or planned) driving trajectories from the trajectory generation system 216. However, when an error (e.g., component/system failure, exception, etc.) is detected within one or more vehicle systems, the trajectory generation computing device 204 may transition to providing safety trajectories (e.g., safe stopping trajectories) from the safety system 218.

As shown in this example, the trajectory generation computing device(s) 204 may generate multiple trajectories at concurrent times (e.g., similar or identical times) during the operation of the vehicle 102. For example, at a particular time, the trajectory generation system 216 may use a driving trajectory algorithm to generate a primary driving trajectory for navigating the vehicle 102 towards its intended destination. At the same particular time (and/or substantially simultaneously—e.g., within computational limits), the safety system 218 may use one or more safety algorithms (different from the driving trajectory algorithm) to generate one or more safety trajectories, such as to decelerate, pull over, and/or bring the vehicle to a quick and safe stop.

In some cases, the safety system 218 may generate multiple safety trajectories having different effective times. The effective time of a trajectory may refer to the starting time (or starting vehicle state) of the trajectory, the time at which the controls of the associated trajectory are to be implemented. In some cases, the safety system 218 may generate a safety trajectory having an effective time corresponding to the current time, which also may correspond to the effective time of the primary driving trajectory was generated by the trajectory generation system 216. Additionally, the safety system 218 may generate a safety trajectory for a future effective time. For instance, the safety system 218 may generate a future safety trajectory associated with a future time by using the primary driving trajectory to predict the vehicle state (e.g., location, pose, velocity, etc.) for the vehicle 102 at the future time when the vehicle may be transitioned to the safety trajectory.

In some examples, the safety system 218 may generate a future safety trajectory based on the time threshold of the trajectory loss timer used by the trajectory execution computing device 206. For example, if the trajectory loss timer 232 uses a time threshold of 500 milliseconds to determine when a trajectory loss event has occurred, then the safety system 218 may generate a future safety trajectory for 500 milliseconds into the future. The safety algorithm used by the safety system 218 to generate the future safety trajectory may be the same safety algorithm used by the safety system 230, so that the future safety trajectory (e.g., current time plus 500 milliseconds) generated by the safety system 218 may be identical to or may closely resemble the present safety trajectory that the safety system 230 may generate 500 milliseconds in the future after determining that a persistent trajectory loss event is occurring.

The future safety trajectory validator 222 may be implemented on the trajectory generation computing device(s) 204 and used to validate the future trajectories generated by the safety system 218. The validate a future safety trajectory corresponding to a trajectory loss event on the trajectory execution computing device 206, the future safety trajectory validator 222 may initially determine the future state of the vehicle 102 at the starting time of the future safety trajectory. The future state of the vehicle 102 may be determined by following the primary driving trajectory generated by the trajectory generation system 216 until the effective time of the future safety trajectory is reached (e.g., the time threshold of the trajectory loss timer). The future safety trajectory validator 222 may then apply the safety algorithm to the determined future state of the vehicle, and then evaluate the resulting trajectory to determine whether it is kinematically feasible and/or safe. In some examples, a same or similar algorithm may be implemented on the trajectory execution computing device.

In some instances, if performing a future safety trajectory would cause the vehicle to continue longitudinally beyond (e.g., drive past) the final trajectory point of the primary driving trajectory generated by the trajectory generation system 216, then the future safety trajectory validator 222 may determine that the future safety trajectory fails validation. A failing validation result for the future safety trajectory may indicate that, if the trajectory execution computing device 206 experiences a persistent trajectory loss event in the future and needs to transition to a safety trajectory, then the safety trajectory that will be generated by the safety system 230 might not be a kinematically feasible or safe trajectory. In contrast, a passing validation result for the future safety trajectory may indicate that, if the trajectory execution computing device 206 experiences a persistent trajectory loss event in the future and needs to transition to a safety trajectory, then the safety trajectory that will be generated by the safety system 230 is likely to be a kinematically feasible and safe trajectory.

When the future safety trajectory validator 222 determines a failing result for a future safety trajectory generated by the safety system 218, the trajectory generation computing device 204 may perform one or more responsive actions. For instance, based on a validation failure for a future safety trajectory, the trajectory generation computing device 204 may initiate an immediate vehicle pullover command, initiate a delayed vehicle pullover command (e.g., within 10 mins, 30 mins, 60 mins, etc.), transmit a notification to a remote operator system, and/or revising the primary driving trajectory. In some cases, the trajectory generation computing device 204 may initiate a driving restriction on the vehicle 102 in response to a failing validation of a future safety trajectory, which may include initiating a pullover requirement for the vehicle within a time period, setting a limitation on a maximum driving speed for the vehicle 102 (e.g., to reduce the severity of any potential future collision), and/or determining a reducing geofence area (e.g., permitted driving area) for the vehicle 102 (e.g., to reduce the probability and/or severity of any potential future collision).

In some examples, after initiating a driving restriction on the vehicle 102, by the trajectory generation computing device 204, based on a failing validation of a future safety trajectory, the trajectory generation computing device 204 may cancel the driving restriction after successfully validating a subsequent future safety trajectory. As an example, the trajectory generation computing device 204 may generate a first future safety trajectory at a timestamp of 0-milliseconds (but having an effective future time of 500-milliseconds). If the first future safety trajectory fails validation by the future safety trajectory validator 222, then the trajectory generation computing device 204 may initiate a driving restriction on the vehicle 102. However, at the next (or any subsequent) timestamp the trajectory generation computing device 204 may generate a second future safety trajectory at a timestamp of 100-milliseconds (but having an effective future time of 600-milliseconds). If the second future safety trajectory passes validation by the future safety trajectory validator 222, then the trajectory generation computing device 204 may cancel the driving restriction and restore the vehicle 102 to its full capabilities.

The trajectory execution computing device 206 may be similar or identical to the trajectory execution system 106 described in FIG. 1. As shown in this example, the trajectory execution computing device 206 may include a trajectory repository 224, a safety system 230, a trajectory loss timer 232, and a vehicle control system 234. The safety system 230 and the trajectory loss timer 232 may correspond respectively to the safety system 112 and the trajectory loss timer 110 described above in FIG. 1. The vehicle control system 234 may be configured to generate and transmit control instructions to the actuators of the vehicle drive system to perform the trajectory determined by the trajectory execution computing device 206.

In this example, the trajectory execution computing device 206 may include a trajectory repository 224 configured to receive and trajectories 200 received from the trajectory generation computing device 204 (e.g., driving trajectories and/or safety trajectories). The trajectory repository 224 also may receive and store safety trajectories generated by the safety system 230. Thus, as shown in this example, the vehicle 102 may include multiple safety systems, such as safety system 218 and safety system 230. In such examples, when the trajectory execution computing device 206 determines that a transition is needed from the current driving trajectory to a safety trajectory, it may select one of the multiple safety trajectories 228 in the trajectory repository 224 based on various selection criteria and/or evaluation of the safety trajectories 228. In some cases, the trajectory execution computing device 206 may select a safety trajectory generated by the safety system 230 when the vehicle error or malfunction that causes the transition to a safety trajectory is a persistent trajectory loss event, then the trajectory execution computing device 206, but may select the safety trajectory generated by the safety system 218 for other types of vehicle errors or malfunctions.

The trajectory repository 224 may store one or more driving trajectories 226, as well as one or more safety trajectories 228. For example, the multiple driving trajectories 226 and multiple safety trajectories 228 may include trajectories generated at different times and/or having different effective times. The effective time of a trajectory may refer to the starting time (or starting vehicle state) of the trajectory. In some cases, such as for primary driving trajectories, the effective time of the trajectory may be the time that the trajectory was generated by the trajectory generation system 216. However, as discussed above, certain safety trajectories may be generated for future effective times. For instance, the safety system 230 may generate a future safety trajectory associated with a future time by predicting the state data (e.g., location, pose, velocity, etc.) for the vehicle 102 at the future time when the vehicle may be transitioned to the safety trajectory. In some examples, the safety system 230 may use the time threshold of the trajectory loss timer to determine the future effective time for a safety trajectory. In such examples, if the trajectory loss reaches the time threshold, then the future effective time of the safety trajectory will have been reached and the safety trajectory can be performed with minimal abrupt, jerky, or unsafe driving maneuvers.

In some examples, the trajectory repository 224 might store only the most recent driving trajectories and/or safety trajectories generated by the safety systems on the vehicle 102. However, in other examples, the trajectory repository 224 may store one or more older driving trajectories and/or safety trajectories. These older trajectories may be used as backup trajectories, for example, if a more recent (e.g., current) driving trajectory or safety trajectory is determined to be corrupted, unsafe, or kinematically infeasible.

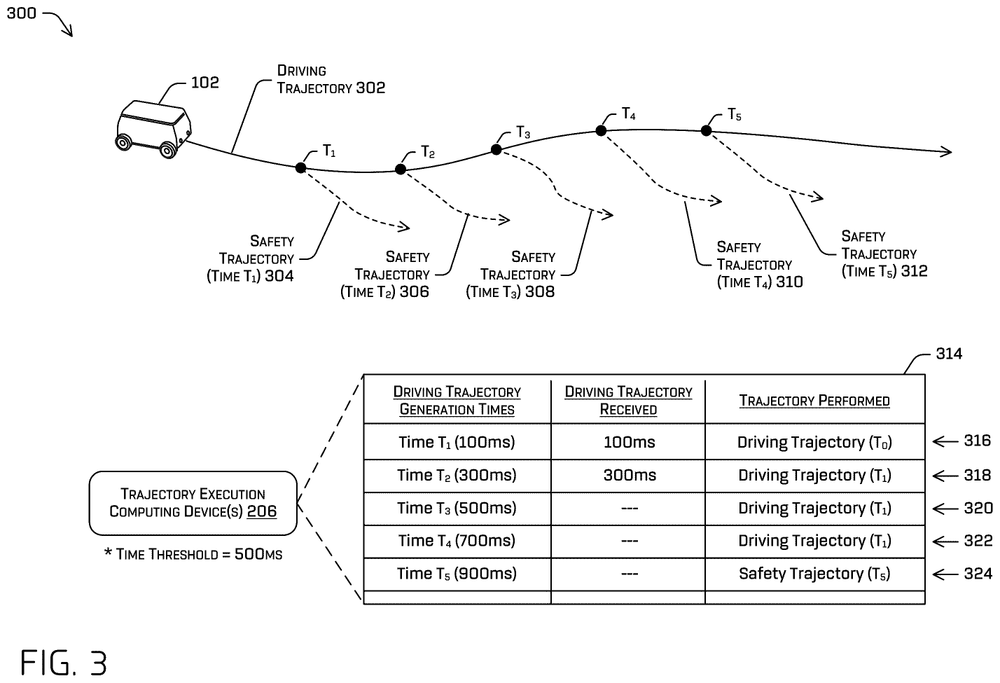

FIG. 3 shows a diagram 300 including a vehicle 102 following a driving trajectory 302 through an environment. FIG. 3 also illustrates the operations of the trajectory execution computing device 206, including maintaining a trajectory loss timer 232 and using the trajectory loss timer 232 to determine when to transition the vehicle 102 to a safety trajectory.

As shown, at various times (e.g., T₁ to T₅) when following the driving trajectory 302, the vehicle 102 may determine new trajectories, including new primary driving trajectories to be followed by the vehicle 102 and new safety trajectories that may be performed if the vehicle 102 needs to be transitioned to a safety trajectory. As described herein, various different systems of the vehicle 102 may generate the periodic driving trajectories and safety trajectories, according to one or more predetermined schedules or frequencies. In this example, every 200 ms the trajectory generation computing device 204 may be configured to generate and transmit a new driving trajectory to the trajectory execution computing device 206. Concurrently, using the same predetermined schedule or a different schedule, the trajectory execution computing device 206 may periodically generate new safety trajectories. Therefore, in this example, the driving trajectory 302 may be generated by the trajectory generation computing device 204 (or trajectory generation system 104), while each of the periodic safety trajectories 304-312 may be generated by the trajectory execution computing device 206 (or trajectory execution system 106). As a result, if a trajectory loss event occurs on the vehicle 102, the trajectory execution computing device 206 may continue to generate safety trajectories during the trajectory loss that are associated with the current time and current state of the vehicle 102.

Table 314 illustrates the operation of the trajectory loss timer 232 within the trajectory execution computing device 206. In this example, the time threshold (e.g., trajectory staleness threshold) used by the trajectory loss timer 232 may be set to 500 ms. During normal driving operations, the trajectory execution computing device 206 in this example may receive a new driving trajectory from the trajectory generation computing device 204 approximately every 200 ms.

In this example, at time T₁ (shown in line 316), the trajectory execution computing device 206 receives a new primary driving trajectory from the trajectory generation computing device 204 at a reference timestamp of reference timestamp of 100-milliseconds(ms). At or around this same time, the safety system 230 of the trajectory execution computing device 206 also may generate a new safety trajectory 304 associated with time T₁. However, because an updated primary driving trajectory was received (and validated by the trajectory execution computing device 206), the trajectory execution computing device 206 may reset the trajectory loss timer 232 to zero and the vehicle control system 234 may execute the time T₁ primary driving trajectory.

At time T₂ in this example (shown in line 318), the trajectory execution computing device 206 receives another new primary driving trajectory from the trajectory generation computing device 204 at reference timestamp 300 ms. At or around this same time, the safety system 230 of the trajectory execution computing device 206 also may generate a new safety trajectory 306 associated with time T₂. However, because an updated primary driving trajectory was received (and validated by the trajectory execution computing device 206), the trajectory execution computing device 206 may again reset the trajectory loss timer 232 to zero and the vehicle control system 234 may execute the time T₂ primary driving trajectory.

At time T₃ in this example (shown in line 320), a trajectory loss event has occurred and the trajectory execution computing device 206 does not receive the scheduled driving trajectory from the trajectory generation computing device 204 at reference timestamp 500 ms. At time T₃, the trajectory loss timer may be 200 ms, and the safety system 230 of the trajectory execution computing device 206 also may generate a new safety trajectory 308 associated with time T₃. However, because the trajectory loss timer is below the time threshold of 500 ms, the trajectory execution computing device 206 may continue to execute the time T₂ (e.g., most recently received) driving trajectory from the trajectory generation computing device 204.

At time T₄ in this example (shown in line 322), the trajectory loss event has continued and the trajectory execution computing device 206 still has not received a new driving trajectory from the trajectory generation computing device 204 at reference timestamp 700 ms. At time T₄, the trajectory loss timer may be 400 ms, and the safety system 230 of the trajectory execution computing device 206 also may generate a new safety trajectory 310 associated with time T₄. However, because the trajectory loss timer is below the time threshold of 500 ms, the trajectory execution computing device 206 may continue to execute the time T₂ (e.g., most recently received) driving trajectory from the trajectory generation computing device 204.

At time T₅ in this example (shown in line 324), the trajectory loss event has continued and the trajectory execution computing device 206 still has not received a new driving trajectory from the trajectory generation computing device 204 at reference timestamp 900 ms. At time T₅, the trajectory loss timer may be 600 ms, and the safety system 230 of the trajectory execution computing device 206 may generate a new safety trajectory 312 associated with time T₅. At this point, because the trajectory loss timer has exceeded the time threshold of 500 ms, the trajectory execution computing device 206 may transition the vehicle 102 from the time T₂ driving trajectory to the time T₅ safety trajectory 312 generated by the safety system 230. As described above, the time T₅ safety trajectory 312 may be designed to start from point T₅ in the driving trajectory 302, which may be the closest available approximation to the current location and state (e.g., pose, velocity, steering angle, etc.) of the vehicle 102 at time T₅.

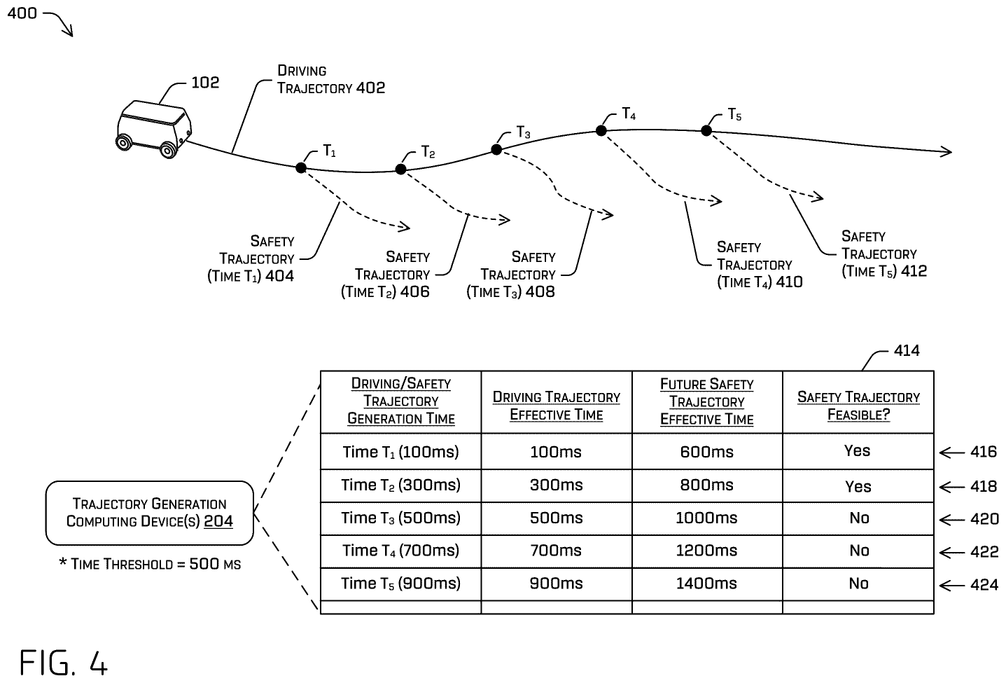

FIG. 4 shows another diagram 400 including a vehicle 102 following a driving trajectory 402 through an environment. FIG. 4 also illustrates operations of the trajectory generation computing device 204, including generating and evaluating future safety trajectories based on the time threshold of the trajectory loss timer 232.

As in the previous example, at various times (e.g., T₁ to T₅) when following the driving trajectory 402, the vehicle 102 may determine new primary driving trajectories as well as new safety trajectories that may be performed if the vehicle 102 needs to be transitioned to a safety trajectory. Both the primary driving trajectory 402 and the safety trajectories 404, 406, 408, 410, and 412 in this example may be generated by the trajectory generation computing device 204, for instance, by the trajectory generation system 216 and the safety system 218 respectively.

In this example, in accordance with a predetermined schedule/frequency of 200 ms, the trajectory generation computing device 204 may be configured to generate (at least) three trajectories. As a first trajectory, the trajectory generation system 216 may generate a primary driving trajectory at each periodic time to control the vehicle from its current location/state to an intended end/target state. As a second trajectory, the safety system 218 may generate a safety trajectory associated with the current time, and that starts from the current vehicle state (e.g., safety trajectories 404-412). Additionally, as a third trajectory, the safety system 218 may generate a future safety trajectory associated with a future effective time corresponding to the current time plus the time threshold of the trajectory loss timer 232 (e.g., 500ms).

Table 414 illustrates the operations of the trajectory generation computing device 204 in generating and evaluating future safety trajectories. In this example, the time threshold (or trajectory staleness threshold) used by the trajectory loss timer 232 may be set to 500 ms. Accordingly, at each time T₁ to T₅, the safety system 218 of the trajectory generation computing device 204 may generate a future safety trajectory having an effective time equal to the current time plus 500 ms. For example, at time T₁ (line 416) having a reference timestamp of 100 ms, the safety system 218 may generate a future safety trajectory having an effective time of 600 ms. Similarly, at each of the times T₂ to T₅ (lines 418, 420, 422, and 424), the safety system 218 may generate future safety trajectories having effective times of 500 ms beyond the current time. As described above, to generate the future safety trajectories, the safety system 218 may use the current driving trajectory 402 to predict the vehicle location and/or vehicle state data (e.g., velocity, pose, steering angle, etc.) at the future time, and then may use the appropriate safety algorithm of the safety system 218 to generate a safety trajectory starting at the predicted future vehicle state.

After generating a future safety trajectory, the trajectory generation computing device 204 may evaluate the future safety trajectory to determine whether the future trajectory is safe and kinematically feasible to be performed by the vehicle 102. As shown in this example, at times T₁ and T₂ (lines 416-418) the trajectory generation computing device 204 may determine that the future safety trajectory (generated for the future time when the trajectory loss time threshold may potentially be reached) may be feasible and safe for the vehicle 102 to perform. However, at times T₃ to T₅ (lines 420-424) the trajectory generation computing device 204 may determine that the future safety trajectories may be infeasible and/or unsafe for the vehicle 102. For instance, the future safety trajectories generated at times T₃ to T₅ may cause the vehicle 102 to drive past the stopping point of the primary driving trajectory 402, and thus may be unsafe or infeasible for the vehicle to perform.

Based on the evaluations of the future safety trajectories, the trajectory generation computing device 204 may perform one or more responsive actions. For example, when a single future safety trajectory, or a number of successive future safety trajectories meeting a time threshold, are evaluated as being unsafe or infeasible then trajectory generation computing device 204 may initiate an immediate or delayed vehicle pullover command. Additionally or alternatively, the trajectory generation computing device 204 may transmit a notification to a remote operator system, and/or may revise the primary driving trajectory 402 to make the future safety trajectories safe and feasible.

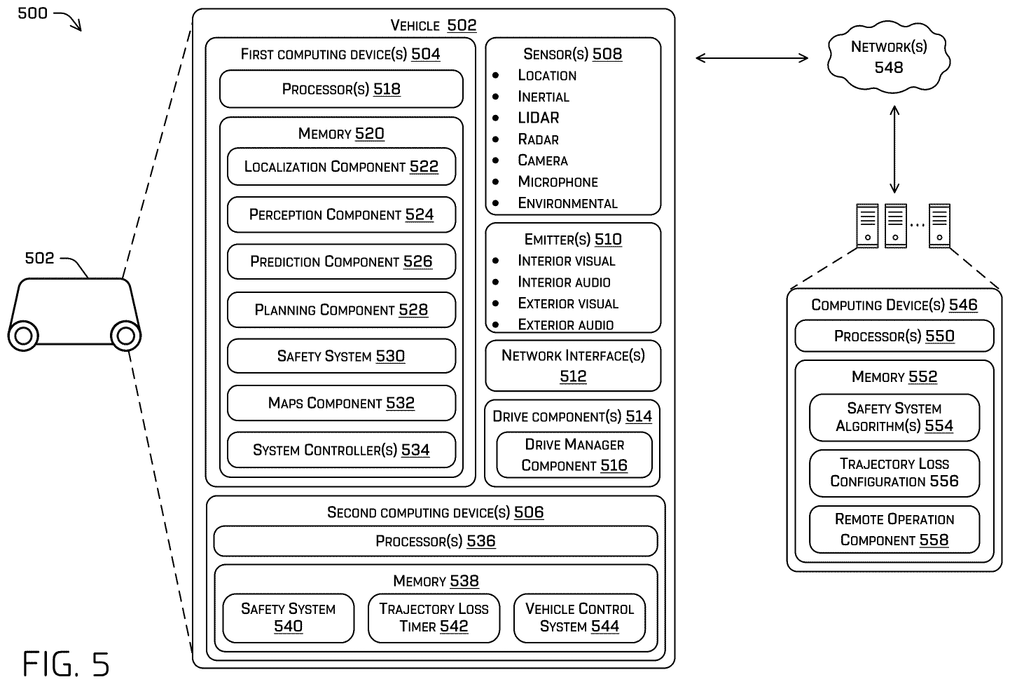

FIG. 5 depicts a block diagram of an example architecture 500 for implementing various techniques discussed herein. In some instances, the example architecture 500 may include a vehicle 502, which may represent the vehicle 102 in FIGS. 1-4. In some instances, the vehicle 502 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 502 may be a fully or partially autonomous vehicle having any other level or classification. Moreover, in some instances, the techniques described herein may be usable by non-autonomous vehicles as well.

The vehicle 502 may include one or more first computing device(s) 504, one or more second computing device(s) 506, one or more sensor(s) 508, one or more emitter(s) 510, one or more network interface(s) 512 (also referred to as communication devices and/or modems), and/or one or more drive component(s) 514. In some instances, the one or more sensor(s) 508 may include time-of-flight sensors, location sensors (e.g., GPS, compass, etc.), inertial sensors (e.g., inertial measurement units (IMUs), accelerometers, magnetometers, gyroscopes, etc.), lidar sensors, radar sensors, sonar sensors, infrared sensors, cameras (e.g., RGB, IR, intensity, depth, etc.), microphone sensors, environmental sensors (e.g., temperature sensors, humidity sensors, light sensors, pressure sensors, etc.), ultrasonic transducers, wheel encoders, etc. The one or more sensor(s) 508 may include multiple instances of each of these or other types of sensors. For instance, the time-of-flight sensors may include individual time-of-flight sensors located at the corners, front, back, sides, and/or top of the vehicle 502. As another example, the camera sensors may include multiple cameras disposed at various locations about the exterior and/or interior of the vehicle 502. The one or more sensor(s) 508 may provide input to the first computing device(s) 504 and/or the second computing device(s) 506.

The one or more emitter(s) 510 may emit light and/or sound. The one or more emitter(s) 510 in this example may include interior audio and visual emitters to communicate with passengers of the vehicle 502. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The one or more emitter(s) 510 in this example may also include exterior emitters. By way of example and not limitation, the exterior emitters in this example may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which may comprise acoustic beam steering technology.

The vehicle 502 may also include one or more network interface(s) 512 that enable communication between the vehicle 502 and one or more other local or remote computing device(s) (e.g., a remote teleoperation computing device) or remote services. For instance, the one or more network interface(s) 512 may facilitate communication with other local computing device(s) on the vehicle 502. Also, the one or more network interface(s) 512 may allow the vehicle 502 to communicate with other nearby computing device(s) (e.g., other nearby vehicles, traffic signals, etc.). The one or more network interface(s) 512 may include physical and/or logical interfaces for connecting the first computing device(s) 504 and/or the second computing device(s) 506 to another computing device or one or more external networks (e.g., the Internet). For example, the one or more network interface(s) 512 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short range communications (DSRC), or any suitable wired or wireless communications protocol that enables the respective computing device to interface with the other computing device(s).

In at least one example, the vehicle 502 may include one or more drive component(s) 514. In some examples, the vehicle 502 may have a single drive component 514. In at least one example, the vehicle 502 may have multiple drive components 514, where individual drive components 514 may be positioned on opposite ends of the vehicle 502 (e.g., the front and the rear, etc.). In at least one example, the drive component(s) 514 may include the one or more sensor(s) 508 to detect conditions of the drive component(s) 514 and/or the surroundings of the vehicle 502. By way of example and not limitation, the sensor(s) 508 may include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders may be unique to the drive component(s) 514. In some cases, the sensor(s) 508 on the drive component(s) 514 may overlap or supplement corresponding systems of the vehicle 502 (e.g., sensor(s) 508).

The drive component(s) 514 may include many vehicle systems, including a high voltage battery, a motor to propel the vehicle 502, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 514 may include one or more drive manager component(s) 516, which may perform various functionalities of the drive component(s) 514. Furthermore, the drive component(s) 514 also include one or more communication connection(s) that enable communication by the respective drive system with one or more other local or remote computing device(s).

As shown, the first computing device(s) 504 may include one or more processor(s) 518 and memory 520 communicatively coupled with the one or more processor(s) 518. In the illustrated example, the memory 520 of the first computing device(s) 504 stores a localization component 522, a perception component 524, a prediction component 526, a planning component 528, a safety system 530 (which may be the same as the safety system 218 of FIG. 2, a maps component 532, and one or more system controller(s) 534. Though depicted as residing in the memory 520 for illustrative purposes, it is contemplated that the localization component 522, the perception component 524, the prediction component 526, the planning component 528, the safety system 530, the maps component 532, and the one or more system controller(s) 534 may additionally, or alternatively, be accessible to the first computing device(s) 504 (e.g., stored in a different component of vehicle 502) and/or be accessible to the vehicle 502 (e.g., stored remotely).

In the memory 520 of the first computing device(s) 504, the localization component 522 may include functionality to receive data from the sensor(s) 508 to determine a position of the vehicle 502. For example, the localization component 522 may include and/or request/receive a three-dimensional map of an environment and may continuously determine a location of the vehicle 502 within the map. In some instances, the localization component 522 may use SLAM (simultaneous localization and mapping) or CLAMS (calibration, localization and mapping, simultaneously) to receive time-of-flight data, image data, lidar data, radar data, sonar data, IMU data, GPS data, wheel encoder data, or any combination thereof, and the like to accurately determine a location of the vehicle 502. In some instances, the localization component 522 may provide data to various components of the vehicle 502 to determine an initial position of vehicle 502 for generating a trajectory, as discussed herein.

The perception component 524 may include functionality to perform object detection, segmentation, and/or classification. In some examples, the perception component 524 may provide processed sensor data that indicates a presence of an entity that is proximate to the vehicle 502 and/or a classification of the entity as an entity type (e.g., car, pedestrian, cyclist, building, tree, road surface, curb, sidewalk, unknown, etc.). In some instances, the perception component 524 may include functionality to store perception data generated by the perception component 524. In some instances, the perception component 524 may determine a track corresponding to an object that has been classified as an object type. The stored perception data may, in some examples, include fused perception data captured by the vehicle 502. Fused perception data may include a fusion or other combination of sensor data from the sensor(s) 508, such as image sensors, lidar sensors, radar sensors, time of flight sensors, sonar sensors, global positioning system sensors, internal sensors, and/or any combination of these. The stored perception data may additionally or alternatively include classification data including semantic classifications of objects (e.g., pedestrians, vehicles, buildings, road surfaces, etc.) represented in the sensor data.

The stored perception data may additionally or alternatively include track data (positions, orientations, sensor features, etc.) corresponding to motion of objects classified as dynamic objects through the environment. The track data may include multiple tracks of multiple different objects over time. This track data may be mined to identify images of certain types of objects (e.g., pedestrians, animals, etc.) at times when the object is stationary (e.g., standing still) or moving (e.g., walking, running, etc.).

In additional and/or alternative examples, the perception component 524 may provide processed sensor data that indicates one or more characteristics associated with a detected entity and/or the environment in which the entity is positioned. In some examples, characteristics associated with an entity may include, but are not limited to, an x-position (global position), a y-position (global position), a z-position (global position), an orientation, an entity type (e.g., a classification), a velocity of the entity, an extent of the entity (size), etc. Characteristics associated with the environment may include, but are not limited to, a presence of another entity in the environment, a state of another entity in the environment, a time of day, a day of a week, a season, a weather condition, an indication of darkness/light, etc.

The perception component 524 may use perception algorithms to determine a perception based bounding box associated with an object in the environment based on sensor data. For example, the perception component 524 may receive image data from the one or more sensor(s) 508 and classify the image data to determine that an object is represented in the image data. Then, using detection algorithms, the perception component 524 may generate a two-dimensional bounding box and/or a perception based three-dimensional bounding box associated with the object. The perception component 524 may further generate a three-dimensional bounding box associated with the object. The three-dimensional bounding box may provide additional information such as a location, orientation, pose, and/or size (e.g., size, width, height, etc.) associated with the object.

The prediction component 526 may generate one or more probability maps representing prediction probabilities of possible locations of one or more objects in an environment. For example, the prediction component 526 may generate one or more probability maps for vehicles, pedestrians, animals, and the like within a threshold distance from the vehicle 502. In some instances, the prediction component 526 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

The planning component 528 may determine a path for the vehicle 502 to follow to traverse through an environment. For example, the planning component 528 may determine various routes and paths and various levels of detail. In some instances, the planning component 528 may determine a route to travel from a first location (e.g., a current location) to a second location (e.g., a target location). For the purpose of this discussion, a route may be a sequence of waypoints for traveling between two locations. As non-limiting examples, waypoints include streets, intersections, global positioning system (GPS) coordinates, etc. Further, the planning component 528 may generate an instruction for guiding the vehicle 502 along at least a portion of the route from the first location to the second location. In at least one example, the planning component 528 may determine how to guide the vehicle 502 from a first waypoint in the sequence of waypoints to a second waypoint in the sequence of waypoints. In some examples, the instruction may be a path, or a portion of a path. In some examples, multiple paths may be substantially simultaneously generated (i.e., within technical tolerances) in accordance with a receding horizon technique. A single path of the multiple paths in a receding data horizon having the highest confidence level may be selected to operate the vehicle.

In other examples, the planning component 528 may alternatively, or additionally, use data from the perception component 524 and/or the prediction component 526 to determine a path for the vehicle 502 to follow to traverse through an environment. For example, the planning component 528 may receive data from the perception component 524 and/or the prediction component 526 regarding objects associated with an environment. Using this data, the planning component 528 may determine a route to travel from a first location (e.g., a current location) to a second location (e.g., a target location) to avoid objects in an environment. In at least some examples, such a planning component 528 may determine there is no such collision free path and, in turn, provide a path which brings vehicle 502 to a safe stop avoiding all collisions and/or otherwise mitigating damage.

In some instances, the safety system 530 may determine collision probabilities associated with the vehicle 502 and other objects. For example, the safety system 530 may determine the collision probability based on a predicted intersection associated with the vehicle 502 and another object. In some instances, the safety system 530 may determine that a collision is predicted to occur and may determine a safety trajectory designed to perform a safe driving maneuver to bring the vehicle 502 to a safe stop. The safety trajectory, when performed by the vehicle 502, may serve to limit a probability of the collision or reduce a likelihood of the collision occurring. The safety system 530 may also communicatively couple with other components of the vehicle 502 for determining trajectories along which the vehicle 502 is to travel. These trajectories may be determined responsive to a predicted collision, faults at the vehicle 502, and so forth. For example, in instances where a collision is predicted to occur, the safety system 530 may select or determine a safety trajectory along which the vehicle 502 is to travel. In some instances, the safety system 530 may operate alongside or in conjunction with the planning component 528 to determine the trajectory.

The memory 520 may further include one or more maps component(s) 532 that may be used by the vehicle 502 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: covariance data (e.g., represented in a multi-resolution voxel space), texture information (e.g., color information (e.g., RGB color information, Lab color information, HSV/HSL color information), and the like), intensity information (e.g., LIDAR information, RADAR information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some instances, the map may be stored in a tiled format, such that individual tiles of the map represent a discrete portion of an environment, and may be loaded into working memory as needed, as discussed herein. In at least one example, the one or more maps component 532 may include at least one map (e.g., images and/or a mesh). In some examples, the vehicle 502 may be controlled based at least in part on the maps component 532. That is, the maps component 532 may be used in connection with the localization component 522, the perception component 524 (and sub-components), the prediction component 526, and/or the planning component 528 to determine a location of the vehicle 502, identify objects in an environment, generate prediction probability(ies) associated with objects and/or the vehicle 502, and/or generate routes and/or trajectories to navigate within an environment.

In at least one example, the first computing device(s) 504 may include one or more system controller(s) 534, which may be configured to control steering, propulsion, braking, safety, emitters, communication, and other systems of the vehicle 502. These system controller(s) 534 may communicate with and/or control corresponding systems of the drive component(s) 514 and/or other components of the vehicle 502, which may be configured to operate in accordance with a path provided from the planning component 528.

The vehicle 502 may include the second computing device(s) 506 to provide various additional functionality, such as redundancy, error checking, and/or validation of determinations and/or commands determined by the first computing device(s) 504. In some examples, the first computing device(s) 504 may be considered to be a primary system, while the second computing device(s) 506 may be considered to be a secondary system. The primary system may correspond to the trajectory generation system 104 and/or trajectory generation computing devices 204 described above, and generally may perform processing to control how the vehicle 502 maneuvers within an environment. The primary system may implement various Artificial Intelligence (AI) techniques, such as machine learning, to understand an environment around the vehicle 502 and/or instruct the vehicle 502 to move within the environment. For example, the primary system may implement the AI techniques to localize the vehicle 502, detect an object around the vehicle 502, segment sensor data, determine a classification of the object, predict an object track, generate a trajectory for the vehicle 502, and so on. In examples, the primary system processes data from multiple types of sensors on the vehicle 502, such as light detection and ranging (lidar) sensors, radar sensors, image sensors, depth sensors (time of flight, structured light, etc.), and the like.

In some instances, the secondary system may correspond to the trajectory execution system 106 and/or trajectory execution computing devices 206 described above. Among other functionality, the secondary system may execute trajectories generated by the primary system, and may validate operations of the primary system and take over control of the vehicle 502 from the primary system when there is a problem with the primary system. As shown, the second computing device(s) 506 may include one or more processor(s) 536 and memory 538 communicatively coupled with the one or more processor(s) 536. In the illustrated example, the memory 538 of the second computing device(s) 506 stores safety system 540 (which may be the same as the safety system 230 of FIG. 2), a trajectory loss timer 542 (which may be the same as the trajectory loss timer 232 of FIG. 2), and a vehicle control system 544 (which may be the same as the vehicle control system 234 of FIG. 2).

The vehicle 502 may connect to computing device(s) 546 via a network 548 and may include one or more processor(s) 550 and memory 552 communicatively coupled with the one or more processor(s) 550. In at least one instance, the one or more processor(s) 550 may be similar to the processor(s) 518 and/or the processor(s) 536, and the memory 552 may be similar to the memory 520 and/or the memory 538. In the illustrated example, the memory 552 of the computing device(s) 546 stores one or more safety system algorithms 554, trajectory loss configuration data 556, and/or a remote operation component 558. In at least one instance, the safety system algorithms 554 may include various safety algorithms (e.g., deceleration rates and/or profiles, lateral movements, target destinations, etc.) that may be provided to the safety systems within the first computing device(s) 504 and the second computing device(s) 506. The safety system algorithms 554 may include associated execution conditions so that each safety system on the vehicle may execute different safety algorithms in different driving conditions, different driving environments, different vehicle states, etc. The trajectory loss configuration data 556 may include, for example, the configurable time threshold values to be provide to the trajectory loss timer 542. Though depicted as residing in the memory 552 for illustrative purposes, it is contemplated that the safety system algorithms 554, trajectory loss configuration data 556, and/or remote operation component 558 may additionally, or alternatively, be accessible to the computing device(s) 546 (e.g., stored in a different component of computing device(s) 546 and/or be accessible to the computing device(s) 546 (e.g., stored remotely).

The processor(s) 518 of the first computing device(s) 504, the processor(s) 536 of the second computing device(s) 506, and the processor(s) 550 of the computing device(s) 546 may be any suitable processor capable of executing instructions to process data and perform operations as described herein. By way of example and not limitation, the processor(s) 518, 536, and 550 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 520 of the first computing device(s) 504, the memory 538 of the second computing device(s) 506, and the memory 552 of the computing device(s) 546 are examples of non-transitory computer-readable media. The memory 520, 538, and 552 may store an operating system and one or more software applications, instructions, programs, and/or data to implement the methods described herein and the functions attributed to the various systems. In various implementations, the memory 520, 538, and 552 may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, aspects of some or all of the components discussed herein may include any models, algorithms, and/or machine learning algorithms. For example, in some instances, the components in the memory 520, 538, and 552 may be implemented as a neural network.

As described herein, an exemplary neural network is an algorithm which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such algorithms in which an output is generated based on learned parameters.

Although discussed in the context of neural networks, any type of machine learning may be used consistent with this disclosure. For example, machine learning or machine learned algorithms may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

### EXAMPLE CLAUSES

A. A vehicle comprising: a first computing device comprising one or more first processors, and one or more non-transitory computer-readable media storing first computer-executable instructions that, when executed, cause the first computing device to perform operations comprising: determining a driving trajectory for the vehicle to navigate an environment, wherein the driving trajectory is associated with a current time, and wherein the vehicle includes a second computing device configured to use the driving trajectory to navigate the environment; determining, based at least in part on a trajectory loss timer associated with the second computing device, a future time after the current time; determining a safety trajectory for the vehicle having a start of execution at the future time; validating, in accordance with a validation algorithm, the safety trajectory to determine a validation result associated with the safety trajectory; transmitting the driving trajectory to the second computing device; and transmitting the safety trajectory to the second computing device, wherein the second computing device comprises one or more second processors, and one or more second non-transitory computer-readable media storing second computer-executable instructions that, when executed, cause the second computing device to perform operations comprising: receiving the driving trajectory; receiving the safety trajectory; validating, in accordance with the validation algorithm, the safety trajectory to determine a second validation result associated with the safety trajectory; and controlling the vehicle based at least in part on the validation result associated with safety trajectory.

B. The vehicle of paragraph A, wherein controlling the vehicle comprises: determining, at the second computing device, to execute the safety trajectory based at least in part on determining that the trajectory loss timer has reached or exceeded a time threshold.

C. The vehicle of paragraph A, wherein controlling the vehicle comprises: initiating a driving restriction on the vehicle, based at least in part on a failing second validation result associated with the safety trajectory, wherein initiating the driving restriction comprises at least one of: initiating a pullover requirement for the vehicle within a time period; reducing a maximum driving speed for the vehicle; or reducing a permitted driving area for the vehicle.

D. The vehicle of paragraph C, the operations further comprising: determining a second driving trajectory for the vehicle, wherein the second driving trajectory is associated with a second time; determining a second safety trajectory for the vehicle associated with a second future time after the second time; validating the second safety trajectory; and canceling the driving restriction on the vehicle, based at least in part on a passing validation result associated with second safety trajectory.

E. The vehicle of paragraph A, the operations further comprising: determining a latency time associated with transitioning the vehicle from the driving trajectory to the safety trajectory, wherein determining the future time is further based at least in part on the latency time.

F. A method comprising: determining, by a trajectory generation system on a vehicle, a driving trajectory to navigate an environment, wherein the driving trajectory is associated with a current time, and wherein the vehicle includes a trajectory execution system configured to use the driving trajectory to navigate the environment; determining, by the trajectory generation system, based at least in part on a trajectory loss timer associated with the trajectory execution system, a future time after the current time; determining, by the trajectory generation system, a safety trajectory for the vehicle associated with the future time; validating, by the trajectory generation system and using a validation algorithm, the safety trajectory to determine a validation result associated with the safety trajectory; and controlling the vehicle based at least in part on the validation result associated with safety trajectory.

G. The method of paragraph F, wherein: the trajectory generation system uses a safety trajectory algorithm to determine whether the safety trajectory is valid, and the trajectory execution system uses the safety trajectory algorithm to determine whether the safety trajectory is valid.

H. The method of paragraph F, wherein the trajectory execution system is configured to: determine a second safety trajectory; determine whether the second safety system is valid using the validation algorithm; and determine whether the trajectory loss timer has reached or exceeded a time threshold, wherein controlling the vehicle comprises executing the second safety trajectory based on the second safety system being valid and the trajectory loss timer reaching or exceeding the threshold time.

I. The method of paragraph F, wherein controlling the vehicle comprises: initiating a driving restriction on the vehicle, based at least in part on a failing validation result associated with the safety trajectory, wherein initiating the driving restriction comprises at least one of: initiating a pullover requirement for the vehicle within a time period; reducing a maximum driving speed for the vehicle; or reducing a permitted driving area for the vehicle.

J. The method of paragraph I, further comprising: determining a second driving trajectory for the vehicle, wherein the second driving trajectory is associated with a second time; determining a second safety trajectory for the vehicle associated with a second future time after the second time; validating the second safety trajectory; and canceling the driving restriction on the vehicle, based at least in part on a passing validation result associated with second safety trajectory.

K. The method of paragraph F, further comprising: determining a latency time associated with transitioning the vehicle from the driving trajectory to the safety trajectory, wherein determining the future time is further based at least in part on the latency time.

L. The method of paragraph F, wherein validating the safety trajectory comprises: determining a starting vehicle state associated with the safety trajectory, based at least in part on: the driving trajectory; and a time threshold associated with the trajectory loss timer.

M. The method of paragraph F, wherein the trajectory generation system uses a first trajectory algorithm to determine the driving trajectory, and a second different trajectory algorithm to determine the safety trajectory.

N. One or more non transitory computer readable media storing instructions executable by a processor, wherein the instructions, when executed, cause the processor to perform operations comprising: determining, by a trajectory generation system on a vehicle, a driving trajectory to navigate an environment, wherein the driving trajectory is associated with a current time, and wherein the vehicle includes a trajectory execution system configured to use the driving trajectory to navigate the environment; determining, by the trajectory generation system, based at least in part on a trajectory loss timer associated with the trajectory execution system, a future time after the current time; determining, by the trajectory generation system, a safety trajectory for the vehicle associated with the future time; validating, by the trajectory generation system and using a validation algorithm, the safety trajectory to determine a validation result associated with the safety trajectory; and controlling the vehicle based at least in part on the validation result associated with safety trajectory.

O. The one or more non transitory computer readable media of paragraph N, wherein: the trajectory generation system uses a safety trajectory algorithm to determine whether the safety trajectory is valid, and the trajectory execution system uses the safety trajectory algorithm to determine whether the safety trajectory is valid.

P. The one or more non transitory computer readable media of paragraph N, wherein the trajectory execution system is configured to: determine a second safety trajectory; determine whether the second safety system is valid using the validation algorithm; and determine whether the trajectory loss timer has reached or exceeded a time threshold, wherein controlling the vehicle comprises executing the second safety trajectory based on the second safety system being valid and the trajectory loss timer reaching or exceeding the threshold time.

Q. The one or more non transitory computer readable media of paragraph N, wherein controlling the vehicle comprises: initiating a driving restriction on the vehicle, based at least in part on a failing validation result associated with the safety trajectory, wherein initiating the driving restriction comprises at least one of: initiating a pullover requirement for the vehicle within a time period; reducing a maximum driving speed for the vehicle; or reducing a permitted driving area for the vehicle.

R. The one or more non transitory computer readable media of paragraph Q, the operations further comprising: determining a second driving trajectory for the vehicle, wherein the second driving trajectory is associated with a second time; determining a second safety trajectory for the vehicle associated with a second future time after the second time; validating the second safety trajectory; and canceling the driving restriction on the vehicle, based at least in part on a passing validation result associated with second safety trajectory.

S. The one or more non transitory computer readable media of paragraph N, the operations further comprising: determining a latency time associated with transitioning the vehicle from the driving trajectory to the safety trajectory, wherein determining the future time is further based at least in part on the latency time.

T. The one or more non transitory computer readable media of paragraph N, wherein validating the safety trajectory comprises: determining a starting vehicle state associated with the safety trajectory, based at least in part on: the driving trajectory; and a time threshold associated with the trajectory loss timer.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A vehicle comprising:
a first computing device comprising one or more first processors, and one or more non-transitory computer-readable media storing first computer-executable instructions that, when executed, cause the first computing device to perform operations comprising:
determining a driving trajectory for the vehicle to navigate an environment, wherein the driving trajectory is associated with a current time, and wherein the vehicle includes a second computing device configured to use the driving trajectory to navigate the environment;
determining, based at least in part on a trajectory loss timer associated with the second computing device, a future time after the current time;
determining a safety trajectory for the vehicle having a start of execution at the future time;
validating, in accordance with a validation algorithm, the safety trajectory to determine a validation result associated with the safety trajectory;
transmitting the driving trajectory to the second computing device; and
transmitting the safety trajectory to the second computing device,
wherein the second computing device comprises one or more second processors, and one or more second non-transitory computer-readable media storing second computer-executable instructions that, when executed, cause the second computing device to perform operations comprising:
receiving the driving trajectory;
receiving the safety trajectory;
validating, in accordance with the validation algorithm, the safety trajectory to determine a second validation result associated with the safety trajectory; and
controlling the vehicle based at least in part on the validation result associated with safety trajectory.

2. The vehicle of claim 1, wherein controlling the vehicle comprises:
determining, at the second computing device, to execute the safety trajectory based at least in part on determining that the trajectory loss timer has reached or exceeded a time threshold.

3. The vehicle of claim 1, wherein controlling the vehicle comprises:
initiating a driving restriction on the vehicle, based at least in part on a failing second validation result associated with the safety trajectory, wherein initiating the driving restriction comprises at least one of:
initiating a pullover requirement for the vehicle within a time period;
reducing a maximum driving speed for the vehicle; or
reducing a permitted driving area for the vehicle.

4. The vehicle of claim 3, the operations further comprising:
determining a second driving trajectory for the vehicle, wherein the second driving trajectory is associated with a second time;
determining a second safety trajectory for the vehicle associated with a second future time after the second time;
validating the second safety trajectory; and
canceling the driving restriction on the vehicle, based at least in part on a passing validation result associated with second safety trajectory.

5. The vehicle of claim 1, the operations further comprising:
determining a latency time associated with transitioning the vehicle from the driving trajectory to the safety trajectory, wherein determining the future time is further based at least in part on the latency time.

6. A method comprising:
determining, by a trajectory generation system on a vehicle, a driving trajectory to navigate an environment, wherein the driving trajectory is associated with a current time, and wherein the vehicle includes a trajectory execution system configured to use the driving trajectory to navigate the environment;
determining, by the trajectory generation system, based at least in part on a trajectory loss timer associated with the trajectory execution system, a future time after the current time;
determining, by the trajectory generation system, a safety trajectory for the vehicle associated with the future time;
validating, by the trajectory generation system and using a validation algorithm, the safety trajectory to determine a validation result associated with the safety trajectory; and
controlling the vehicle based at least in part on the validation result associated with safety trajectory.

7. The method of claim 6, wherein:
the trajectory generation system uses a safety trajectory algorithm to determine whether the safety trajectory is valid, and
the trajectory execution system uses the safety trajectory algorithm to determine whether the safety trajectory is valid.

8. The method of claim 6, wherein the trajectory execution system is configured to:
determine a second safety trajectory;
determine whether the second safety system is valid using the validation algorithm; and
determine whether the trajectory loss timer has reached or exceeded a time threshold,
wherein controlling the vehicle comprises executing the second safety trajectory based on the second safety system being valid and the trajectory loss timer reaching or exceeding the threshold time.

9. The method of claim 6, wherein controlling the vehicle comprises:
initiating a driving restriction on the vehicle, based at least in part on a failing validation result associated with the safety trajectory, wherein initiating the driving restriction comprises at least one of:
initiating a pullover requirement for the vehicle within a time period;
reducing a maximum driving speed for the vehicle; or
reducing a permitted driving area for the vehicle.

10. The method of claim 9, further comprising:
determining a second driving trajectory for the vehicle, wherein the second driving trajectory is associated with a second time;
determining a second safety trajectory for the vehicle associated with a second future time after the second time;
validating the second safety trajectory; and
canceling the driving restriction on the vehicle, based at least in part on a passing validation result associated with second safety trajectory.

11. The method of claim 6, further comprising:
determining a latency time associated with transitioning the vehicle from the driving trajectory to the safety trajectory, wherein determining the future time is further based at least in part on the latency time.

12. The method of claim 6, wherein validating the safety trajectory comprises:
determining a starting vehicle state associated with the safety trajectory, based at least in part on:
the driving trajectory; and
a time threshold associated with the trajectory loss timer.

13. The method of claim 6, wherein the trajectory generation system uses a first trajectory algorithm to determine the driving trajectory, and a second different trajectory algorithm to determine the safety trajectory.

14. One or more non-transitory computer-readable media storing instructions executable by a processor, wherein the instructions, when executed, cause the processor to perform operations comprising:
determining, by a trajectory generation system on a vehicle, a driving trajectory to navigate an environment, wherein the driving trajectory is associated with a current time, and wherein the vehicle includes a trajectory execution system configured to use the driving trajectory to navigate the environment;
determining, by the trajectory generation system, based at least in part on a trajectory loss timer associated with the trajectory execution system, a future time after the current time;
determining, by the trajectory generation system, a safety trajectory for the vehicle associated with the future time;
validating, by the trajectory generation system and using a validation algorithm, the safety trajectory to determine a validation result associated with the safety trajectory; and
controlling the vehicle based at least in part on the validation result associated with safety trajectory.

15. The one or more non-transitory computer-readable media of claim 14, wherein:
the trajectory generation system uses a safety trajectory algorithm to determine whether the safety trajectory is valid, and
the trajectory execution system uses the safety trajectory algorithm to determine whether the safety trajectory is valid.

16. The one or more non-transitory computer-readable media of claim 14, wherein the trajectory execution system is configured to:
determine a second safety trajectory;
determine whether the second safety system is valid using the validation algorithm; and
determine whether the trajectory loss timer has reached or exceeded a time threshold,
wherein controlling the vehicle comprises executing the second safety trajectory based on the second safety system being valid and the trajectory loss timer reaching or exceeding the threshold time.

17. The one or more non-transitory computer-readable media of claim 14, wherein controlling the vehicle comprises:
initiating a driving restriction on the vehicle, based at least in part on a failing validation result associated with the safety trajectory, wherein initiating the driving restriction comprises at least one of:
initiating a pullover requirement for the vehicle within a time period;
reducing a maximum driving speed for the vehicle; or
reducing a permitted driving area for the vehicle.

18. The one or more non-transitory computer-readable media of claim 17, the operations further comprising:
determining a second driving trajectory for the vehicle, wherein the second driving trajectory is associated with a second time;
determining a second safety trajectory for the vehicle associated with a second future time after the second time;
validating the second safety trajectory; and
canceling the driving restriction on the vehicle, based at least in part on a passing validation result associated with second safety trajectory.

19. The one or more non-transitory computer-readable media of claim 14, the operations further comprising:
determining a latency time associated with transitioning the vehicle from the driving trajectory to the safety trajectory, wherein determining the future time is further based at least in part on the latency time.

20. The one or more non-transitory computer-readable media of claim 14, wherein validating the safety trajectory comprises:
determining a starting vehicle state associated with the safety trajectory, based at least in part on:
the driving trajectory; and
a time threshold associated with the trajectory loss timer.
